(19) United States
(12) Patent Application Publication
(10) Pub. No.: US 2015/0305834 A1
(43) Pub. Date: Oct. 29, 2015

(54) System for securing false tooth and method of use

(71) Applicant: Bryan C. Crafton, Chevy Chase, MD (US)

(72) Inventor: Bryan C. Crafton, Chevy Chase, MD (US)

(21) Appl. No.: 14/695,360

(22) Filed: Apr. 24, 2015

Related U.S. Application Data
(60) Provisional application No. 61/984,330, filed on Apr. 25, 2014.

(51) Int. Cl. A61C 7/16; A61C 13/08; A61C 7/18

(52) U.S. Cl. CPC A61C 7/16; A61C 7/18; A61C 13/08

(57) ABSTRACT

A system of securing a false tooth and method of use of the same.

### CROSS REFERENCE

This application claims priority to and benefit of the following U.S. patent application: U.S. Provisional Patent Application 61/984,330, filed Apr. 25, 2014, which is hereby incorporated by reference herein as if fully set forth herein in its entirety.

### BACKGROUND

The present invention relates generally to false teeth and, more specifically, to a bracket which may be attached to a false tooth.

False teeth are generally used within orthodontic practice to fill a gap where a person may have lost a tooth. Generally, false teeth are modeled after the wearer's real teeth and configured to fit precisely between adjacent teeth and perform as a good option for those looking to fill a void left by a lost tooth. Implants, as another alternative are often costly, painful, and require a certain quality of gum to use, therefore proving false tooth a better option in many circumstances. In addition, a patient may wish to correct all teeth before the use of a permanent implant, therefore, allowing the use of a false tooth in the interim. The incorporation of a false tooth often prevents the use of many orthodontic tools and devices since the false tooth cannot be bonded to or secured in similar ways to a real tooth. In addition, the complexity and price of using a false tooth may often prevent the wearer from using additional orthodontic practices and tools to address specific oral problems.

It may be advantageous to provide a system which: may secure to a false tooth; may provide an attachment mechanism to secure the false tooth to an orthodontic tool; may provide a customized false tooth; may allow for quick and efficient use; can be easily manufactured; is preferably efficient to manufacture; and/or allows the use of a set of braces despite the incorporation of a false tooth.

### SUMMARY

In one aspect, one preferred embodiment of the present invention is directed to a system of securing a false tooth. The system preferably includes a main body of a braces bracket configured to contact the false tooth. The main body may comprise first and second opposing surfaces. An attachment mechanism is preferably also disposed along the second opposing surface of the main body of the braces bracket. The attachment mechanism is preferably configured to engage the false tooth. The main body is preferably also configured to engage a wire such that the main body may be integrated into a set of orthodontic braces.

In another aspect, one embodiment of the present invention is directed to a system of securing a false tooth. The system preferably includes a main body of a braces bracket configured to contact the false tooth. The main body may comprise first and second opposing surfaces. An attachment mechanism is preferably also disposed along the second opposing surface of the main body of the braces bracket. The attachment mechanism is preferably configured to engage the false tooth. The attachment mechanism preferably comprises a pin configured for insertion into the false tooth.

In another aspect, one embodiment of the present invention is directed to a system of securing a false tooth. The system preferably includes a main body of a braces bracket configured to contact the false tooth. The main body may comprise first and second opposing surfaces. An attachment mechanism is preferably also disposed along the second opposing surface of the main body of the braces bracket. The attachment mechanism is preferably configured to engage the false tooth. The attachment mechanism preferably comprises a pin configured for insertion into the false tooth. The pin may further comprise a cement coating in order to facilitate securement of the pin into the false tooth.

In another aspect, one embodiment of the present invention is directed to a system of securing a false tooth. The system preferably includes a main body of a braces bracket configured to contact the false tooth. The main body may comprise first and second opposing surfaces. The first opposing surface may preferably further comprise a plurality of supports disposed thereon configured to provide a catch.

In another aspect, one embodiment of the present invention is directed to a system of securing a false tooth. The system preferably includes a main body of a braces bracket configured to contact the false tooth. The main body may comprise first and second opposing surfaces. The first opposing surface may preferably further comprise a plurality of supports disposed thereon configured to provide a catch. The plurality of supports of preferably configured as a plurality of posts which project perpendicularly away from the first opposing surface of the main body. Additionally, a flange may be disposed along the plurality of posts.

In another aspect, one embodiment of the present invention is directed to a system of securing a false tooth. The system preferably includes a main body of a braces bracket configured to contact the false tooth. The main body may comprise first and second opposing surfaces. The first opposing surface may preferably further comprise a plurality of supports disposed thereon configured to provide a catch. The plurality of supports of preferably configured as a plurality of post which project perpendicularly away from the first opposing surface of the main body. The plurality of posts are preferably configured to engage a band and position the band continuously adjacent to the first opposing surface such that the wire is secured into the set of braces.

In another aspect, one embodiment of the present invention is directed to a system of securing a false tooth. The system preferably includes a main body of a braces bracket configured to contact the false tooth. The main body may comprise first and second opposing surfaces. The first opposing surface may preferably further comprise a plurality of supports, wherein the plurality of supported comprises four posts, the four posts defining a channel to receive the band therein.

In another aspect, one embodiment of the present invention is directed to a system of securing a false tooth. The system preferably includes a main body of a braces bracket configured to contact the false tooth. The main body may comprise first and second opposing surfaces. The second opposing surface is preferably configured to provide a contour which matches the shape of the false tooth.

In another aspect, one embodiment of the present invention is directed to a system of securing a false tooth. The system preferably includes a main body of a braces bracket configured to contact the false tooth. The main body may comprise first and second opposing surfaces. The attachment mechanism may further comprise a cap configured to enclose the false tooth.

In another aspect, one embodiment of the present invention is directed to a system of securing a false tooth. The system preferably includes a main body of a braces bracket configured to contact the false tooth. The main body may comprise first and second opposing surfaces. The attachment mechanism may further comprise a hook configured to engage the false tooth.

In another aspect, one embodiment of the present invention is directed to a system of securing a false tooth. The system preferably includes a main body of a braces bracket configured to contact the false tooth. The main body may comprise first and second opposing surfaces. The attachment mechanism may further comprise a cap configured to enclose the false tooth.

In another aspect, one embodiment of the present invention is directed to a system of securing a false tooth. The system preferably includes a main body of a braces bracket configured to contact the false tooth. The main body may comprise first and second opposing surfaces. The attachment mechanism may further comprise a belt configured to surround a circumference of the false tooth.

In another aspect, one embodiment of the present invention is directed to a system of securing a false tooth. The system preferably includes a main body of a braces bracket configured as a unitary component with a false tooth. The braces bracket and the false tooth are preferably made from the same material and comprise a single, continuous piece. The false tooth and braces bracket may further comprises a color stain or dye to include upon the material of the false tooth and braces bracket.

In another aspect, one preferred embodiment of the present invention is directed to a method of providing a system configured to secure a false tooth. The method may include providing a main body of a brace bracket to engage the false tooth. The method also preferably includes positioning the main body on the false tooth, wherein the main body and the false tooth are configured to be integrated into a set of braces such that the braces can properly position the false tooth when the set of braces are installed.

In another aspect, one preferred embodiment of the present invention is directed to a method of providing a system configured to secure a false tooth. The method may include providing a main body of a brace bracket to engage the false tooth, wherein the step of providing a main body may further comprise providing a plurality of supports configured to provide a catch.

In another aspect, one preferred embodiment of the present invention is directed to a method of providing a customized false tooth. The method may include preparing a customized false tooth for a person, the customized false tooth being shaped according to the orthodontic shape of the person. The method may further include securing a braces bracket directly onto the false tooth. The method may also comprise providing a main body of a brace bracket to engage the false tooth. The method also preferably includes positioning the main body on the false tooth, wherein the main body and the false tooth are configured to be integrated into a set of braces such that the braces can properly position the false tooth when the set of braces are installed.

In another aspect, one preferred embodiment of the present invention is directed to a method of providing a system configured to secure a false tooth. The method may include providing a main body of a brace bracket to engage the false tooth, wherein the step of providing a main body may further comprise providing a post of the main body extending through the false tooth.

### BRIEF DESCRIPTION OF THE DRAWINGS

The foregoing summary, as well as the following detailed description of the preferred embodiments of the invention, will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of one embodiment of the system configured to secure a false tooth; A wearer is shown using the system to secure a set of braces in place.

FIG. 2 is a perspective view of the system illustrating a preferred method of mounting a braces bracket to a false tooth; The braces bracket is shown preferably with a plurality of posts to enable the securement of a band; A pin is also preferably disposed on an opposing surface of the braces bracket to secure within the false tooth.

FIG. 3 is another perspective view of the system of FIG. 2; The braces bracket is shown attached to a false tooth; Preferably a pin is secured within a cavity of the false tooth to ensure the braces bracket remains seated against the false tooth.

FIG. 4 is a cross sectional view of the braces bracket of FIG. 2 as taken along the line 4-4 in FIG. 3; The braces bracket is shown secured against a face of the false tooth preferably with a pin disposed within a cavity of the false tooth; A coating, such as a dental cement, is preferably provided to secure the pin within the cavity, however, those of ordinary skill in the art will appreciate from this disclosure that any suitable adhesive and/or glue may be used without departing from the scope of the invention.

FIG. 5 is another cross sectional view of the braces bracket cover of FIG. 2 as taken along the line 4-4 in FIG. 3 according to alternative embodiment; The pin is preferably shown with a serrated edge to facilitate the securement of the pin within the coating inside the cavity of the false tooth; It should be noted that those of ordinary skill in the art will appreciate from this disclosure that any edge design may be used in conjunction with the pin without departing from the scope of the invention.

FIG. 6 is perspective view of the braces bracket of FIG. 5; The pin, including the serrated edge, is preferably disposed along a second opposing surface of the braces bracket opposite the plurality of posts.

FIG. 7 is a cross-sectional view according to a third preferred embodiment of the present invention; The braces bracket is shown secured to a cap which preferably encloses the outer perimeter of the false tooth; Contrary to the previous embodiment, the braces bracket securement system according to FIG. 7 does not require a cavity or recess in the false tooth and instead provides a cap which fits over the outer surface of the false tooth; It is preferable that the cap match the contour of the false tooth, however, those of ordinary skill in the art will appreciate that the cap may have many different ships and still enclose the false tooth without departing from the scope of the present invention.

FIG. 8 is a cross-sectional view of the braces bracket of FIG. 7; The cap is preferably a friction fit against the false tooth. The cap is also preferably seated against the second opposing surface of the braces bracket. Alternatively, the cap may secured against the false tooth with an adhesive or similar material without departing from the scope of the present invention.

FIG. 9 is a perspective view of the braces bracket according to a fourth embodiment of the invention; The braces bracket is shown with a belt secured along the second opposing surface; Preferably the belt may fit around the perimeter of the false tooth without enclosing an upper portion of the false tooth; The belt preferably provides a clamp to reduce the diameter of the belt in order to facilitate the securement of the band along the false tooth.

FIG. 10 is a cross-sectional view of the system according to FIG. 9 taken along the line 10-10 in FIG. 9; The braces bracket may be secured to the belt with fasteners along the second opposing surface of the braces bracket; The circumference of the belt is also preferably adjusted via the clamp to ensure the belt remains positioned along the false tooth.

FIG. 11 is a perspective view of a fifth embodiment of the securement system; The braces bracket is shown with a belt similar to that of FIG. 9, however, a screw disposed about the braces bracket is preferably used to adjust the circumference of the belt about the false tooth; Those of ordinary skill in the art will appreciate that any suitable fastening means may be used in place of the screw without departing from the scope of the invention.

FIG. 12 is a cross-sectional view of FIG. 11 taken along the line 12-12 in FIG. 11; The threads of the screw preferably control the distance between a first surface and a second surface of the belt such that an adjustment of the screw moves the first and second surfaces along the threads of the screw.

FIG. 13 is another cross-sectional view of the system according to FIG. 12; The first and second surfaces of the belt are shown fastened closer together, thereby providing a smaller circumference for the belt and more secure fastening against the false tooth. Alternatively, any other fastening means may be used to secure the belt without departing from the scope of the present invention.

FIG. 14 is a perspective view of a sixth embodiment of the system; The braces brackets is preferably secured to a belt with free ends; The free ends may allow for a higher degree of adjustment about the false tooth when the belt and braces brackets are placed into position. The free ends of the belt are preferably provided with tapered ends so as to create a seamless transition from the false tooth to the belt.

FIG. 15 is a cross-section view of the system according to FIG. 14 and taken along the line 15-15 in FIG. 14; The braces bracket may be similar adjusted using a screw and interlocking the threads with the first and second surfaces of the belt.

FIG. 16 is a cross sectional view of the braces bracket cover of another embodiment of the present invention similar to that of FIG. 2; The braces bracket is shown secured against a face of the false tooth preferably with a pin disposed through a bore in the false tooth; The pin extends through the false tooth and has a distal end bent downward toward the gum line. The portion of the pin that extends down toward the gum line along a surface of the false tooth that faces the tongue is preferably coated with an adhesive or a dental cement; however, those of ordinary skill in the art will appreciate from this disclosure that any suitable adhesive and/or glue may be used without departing from the scope of the invention.

### DETAILED DESCRIPTION OF THE PREFERRED EMBODIMENTS

Certain terminology is used in the following description for convenience only and is not limiting. The words “right”, “left”, “top”, “bottom”, designate directions in the drawings to which reference is made. The term “vertical” and “horizontal” refer to generally planar positions relative to the structure which the collapsible basket is to be attached. The term “false tooth”, as used in the claims and associated portions of the specification, is defined as meaning “any dental device, implant, or attachment used within the oral cavity”. “Vertical” refers to a generally up and down position, while “horizontal” refers to a generally left to right position. The term “first surface”, as used in the claims and corresponding portions of the specification means any surface configuration not limited by shape or size. The term “second surface” similarly defines any surface without constraint to the size or shape of the surface. The term “cavity” refers to a generally hollow portion of the false tooth. Additionally, the words “a” and “one” are defined as including one or more of the referenced items unless specifically stated otherwise. The terminology includes the words above specifically mentioned, derivatives thereof, and words of similar import.

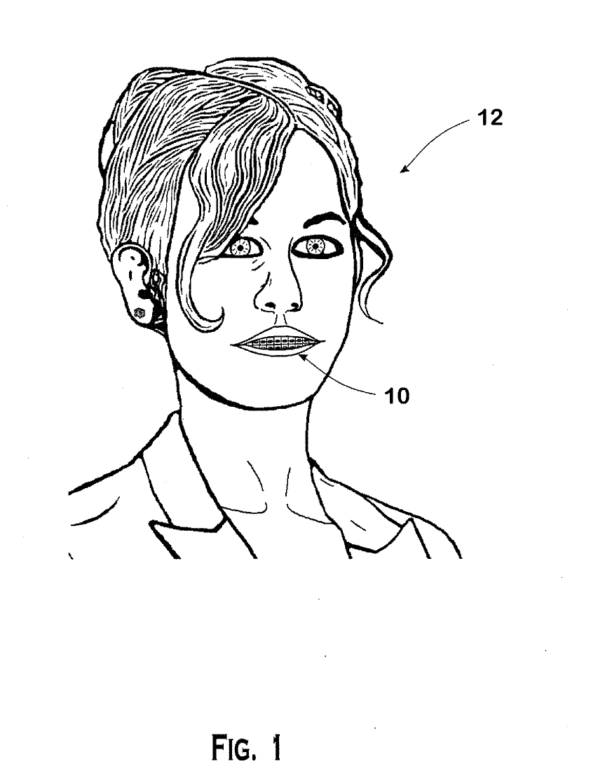

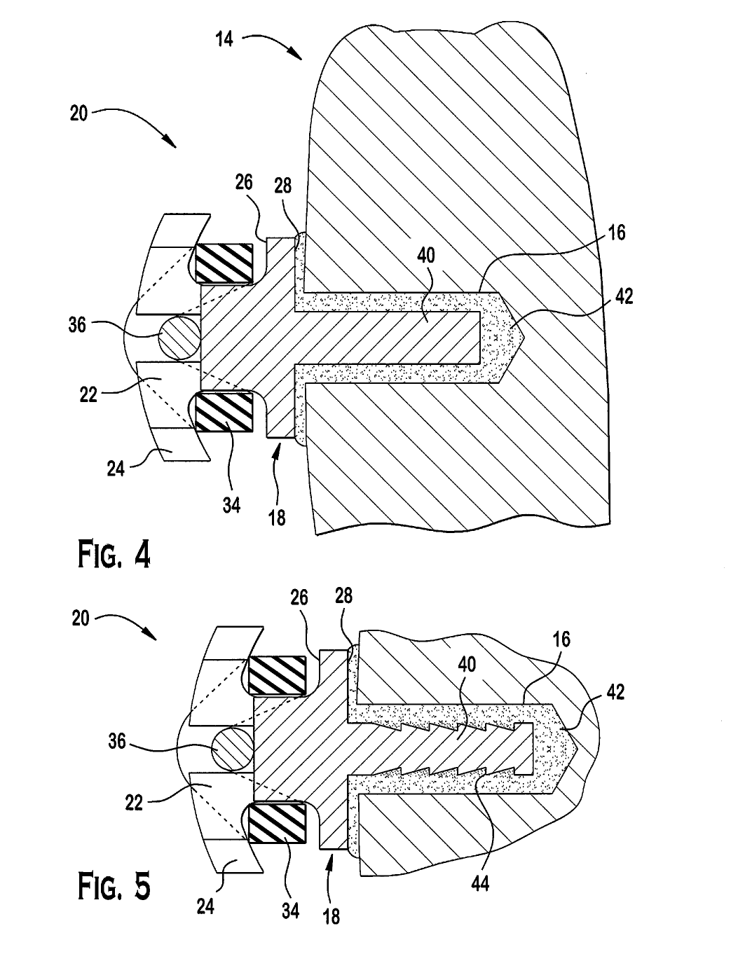

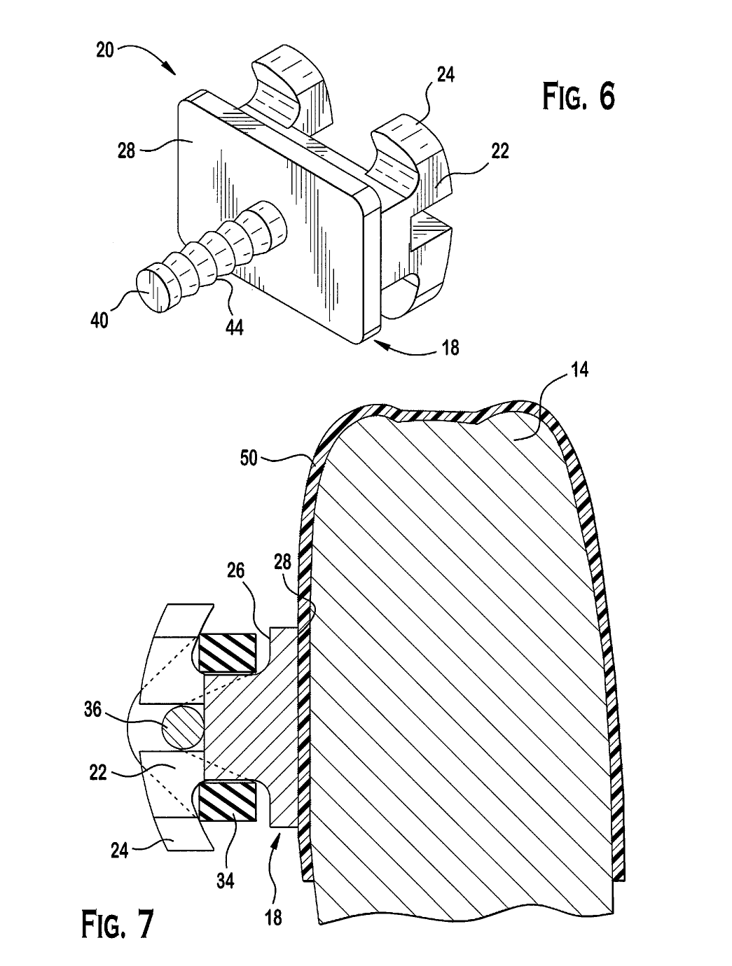

Referring to FIGS. 1-15, wherein like numerals indicate like elements throughout, preferred embodiments of a system for securing a false tooth according to the present invention are shown, wherein the braces bracket is generally designated as 20. The braces bracket 20 may be secured within a set of braces 10 and used in conjunction with a wearer 12 who has false tooth 14.

The braces bracket 20 may be used in conjunction with a standard set of braces 10 when a wearer 12 has a false tooth 14. The braces bracket 20 preferably facilitates the attachment to a false tooth 14, so that braces 10 may appear uniform across the wearer's teeth.

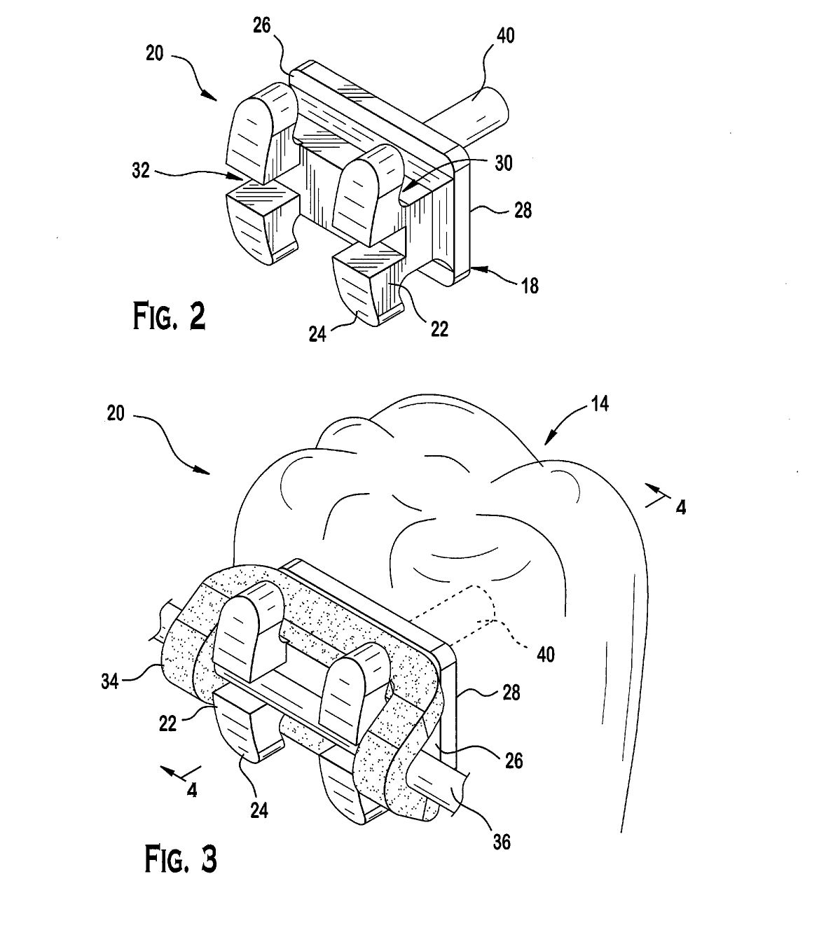

Referring now to FIGS. 2-6, the braces bracket 20 preferably comprises a main body 18 with a first and second opposing surfaces 26, 28. A plurality of posts 22 are preferably disposed along the first opposing surface 26 and configured to project outwardly away from the firs opposing surface 26. While there are four posts 22 illustrated, one of ordinary skill in the art will appreciate that any number of posts may project away from the main body without departing from the scope of the present invention. Each of the posts 22 may further comprise a flange 24 which projects away therefrom, generally parallel to the first opposing surface 26. A channel 32 may further be disposed between the posts 22 so as to engage a wire 36 as part of the braces 10. On the side of the flanges 24 facing the first opposing surface 26, a catch 30 is preferably provided to facilitate engagement with a band 34. The band 34 is preferably an elastic material so as to provide an elastic retention between the catch 30 and over the wire 36.

The braces bracket 20 preferably includes a pin 40 disposed along the second opposing surface 28, configured generally perpendicular to the second opposing surface 28. The pin 40 is configured for insertion into a cavity 16 within the false tooth 14. Referring specifically to FIG. 4, the pin 40 may be inserted into the cavity 16 of the false tooth 14. The pin 40 may be enclosed within the cavity 16 to allow the second opposing surface 28 to meet an exterior surface of the false tooth 14. The cavity is preferably configured to match the shape of the pin 40, however, those of ordinary skill in the art will appreciate from this disclosure that the cavity 16 may be any size and shape without departing from the scope of the present invention. A coating 42 may further be incorporated between the pin 40 and the cavity 16 to facilitate the securement of the pin 40 within the cavity 16. The coating 42 is preferably a dental cement or the like, however, those of ordinary skill in the art will appreciate from this disclosure that any form of adhesive or glue may be used without departing from the scope of the present invention.

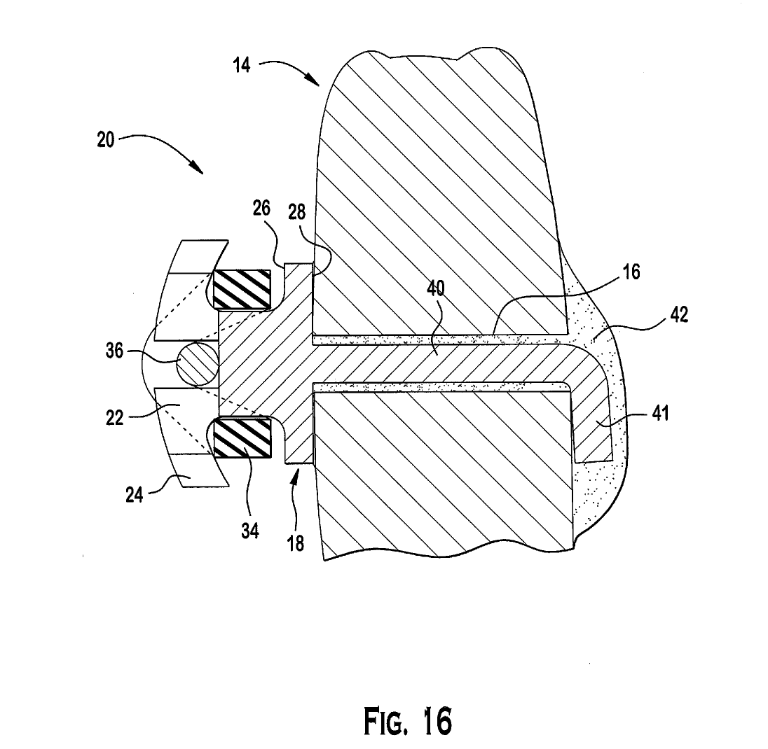

Those of ordinary skill in the art will appreciate from this disclosure that the pin 40 may extend entirely through the false tooth 14. The end of the pin 40 that extends past the tooth can be secured in a plate, putty, back plate or using any other suitable method without departing from the scope of the present invention. Similarly, the pin 40 may be of equal length as the thickness of the tooth so that it lies along the entire length of a bore therethrough and is then held in place with cement or using any other suitable means. Referring to FIG. 16, the pin 40 is shown extending completely through the false tooth 14 with an end 41 protruding past the false tooth. The pin end 41 is preferably bent down towards the gum line and covered with a suitable adhesive, putty, dental cement, or any other suitable material.

The pin 40 may alternately be configured with a serrated edge 44 so as to resist an outward movement of the pin away from the false tooth 14. With the pin 40 in position within the cavity 14, the edge 44 may provide a physical barrier against the coating 42 thereby increasing the surface are over which the securing force is distributed. In such a way, the second opposing surface 28 preferably maintains constant contact with the coating 42 and the exterior of the false tooth 14.

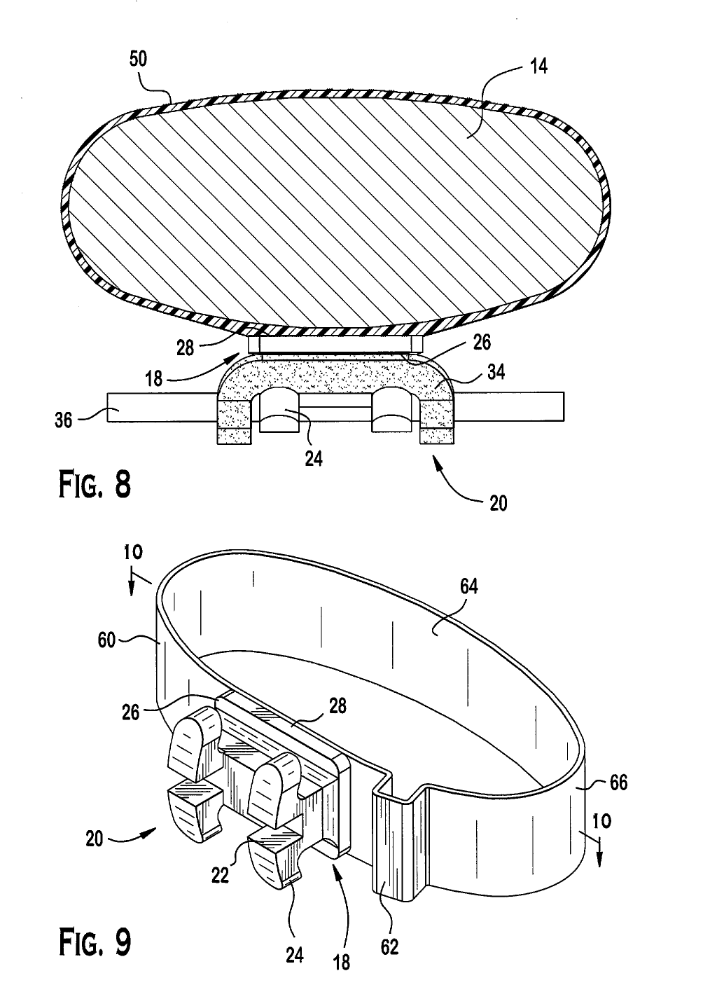

Referring now to FIGS. 7 and 8, another embodiment of the braces bracket 20 is shown. The braces bracket 20, including the plurality of posts 22, flanges 24, band 34, and wire 36 may attach to a cap 50 which is configured to enclose the false tooth 40 around the exterior perimeter thereof. The braces bracket may be secured to the cap 50 through any suitable means, or as a single piece unit, without departing from the scope of the present invention. The braces bracket 20 according to the embodiment illustrated in FIG. 7 does not require a cavity 16 in the false tooth 14, and instead, secures against the exterior surface of the false tooth 14.

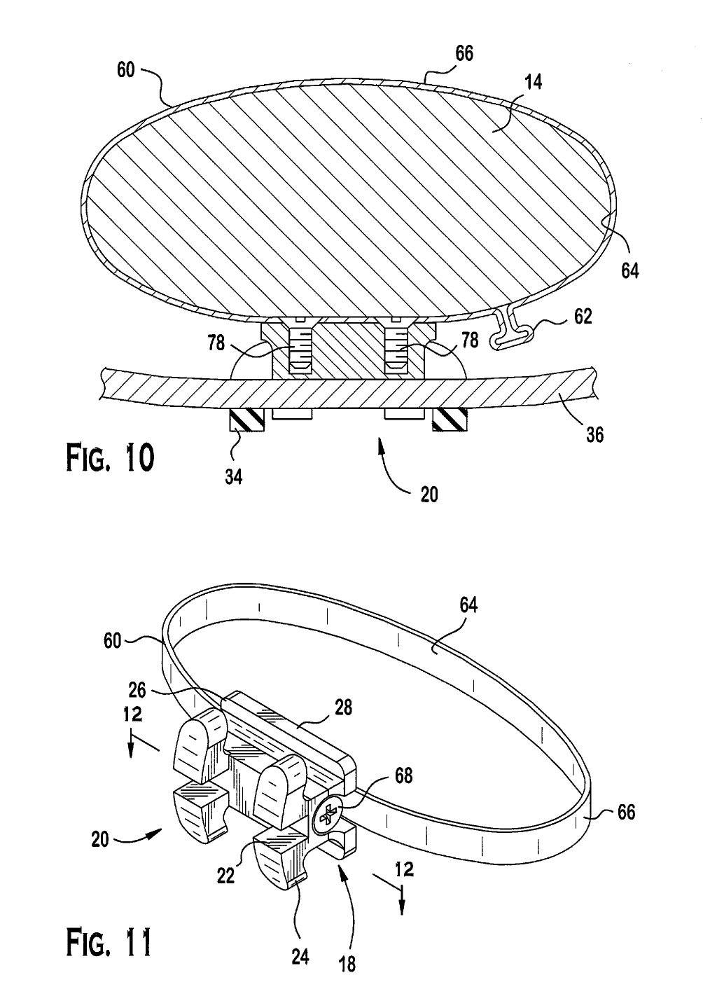

Referring now to FIGS. 9 and 10, another embodiment of the present invention is shown. The braces bracket 20 may alternatively comprises a belt 60 configured to surround an outer circumference of the false tooth 14, leaving the top of the false tooth 14 unenclosed. The braces bracket 20 is similar to that of the previous embodiments, and, may similarly attach to the belt 60 through any suitable means without departing from the scope of the present invention. As illustrated in FIG. 10, the braces bracket 20 is secured to the belt 60 through fasteners 78, which provide threading to engage the main body 18 of the brace bracket 20. The belt 60 may further comprises a clamp 62 in order to facilitate the securement of the belt 60 about the false tooth 14. The belt 60 is preferably made of a flexible metallic material such that the additional material of the clamp 62 may be “pinched” down in order to reduce the overall circumference of the belt 60. Once reduced, the circumference is preferably maintained by the metallic material, which may comprise a mild steel or aluminum, however, any metallic material may be used without departing from the scope of the invention. The false tooth 14 is preferably constructed with grooves and/or channels in the perimeter of the false tooth so as to incorporate the belt 60 seamlessly into the exterior of the false tooth 14. A dental putty or other suitable material may then be coated about the belt 60 to ensure that no rough edges remain from the belt 60 and to provide a seamless transition from the false tooth 14 to the belt 60.

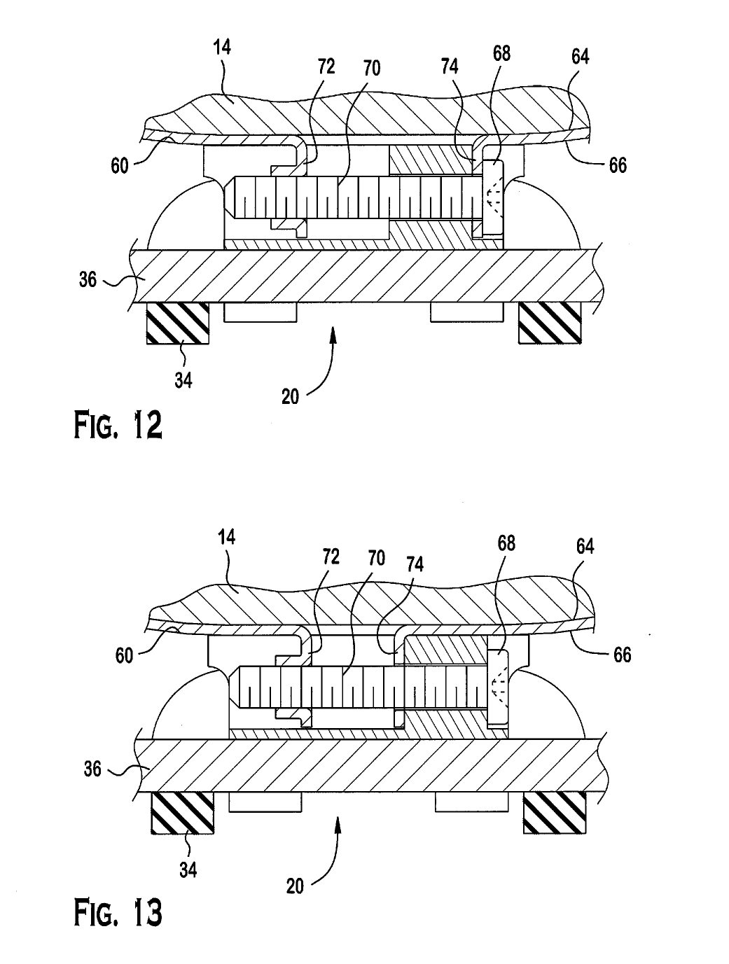

Referring now to FIG. 11-15, another embodiment of the braces bracket 20 is shown. The braces bracket 20 is similar to that of FIGS. 9 and 10, incorporating a belt 60 to secure around a circumference of the false tooth 14. However, a screw 68 may be provided instead of or in addition to the clamp 62 so as to facilitate a securement of the belt 60 about the false tooth 14. The screw 68 preferably provides threads 70 to engage a first surface 72 and a second surface 74 of the belt 60. A rotation of the screw may increase or decrease the distance between the surfaces 72, 74 such that an adjustment of the overall circumference of the belt 60 is provided, as shown in FIGS. 12 and 13.

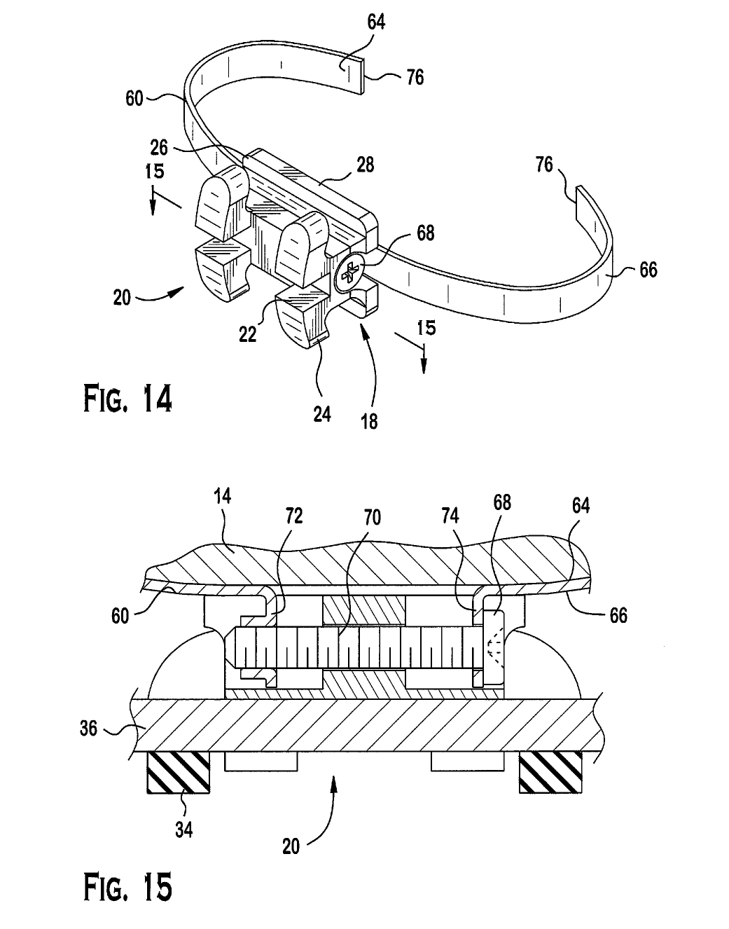

Alternatively, the belt 60 may also comprise free ends 76 along an end opposing the braces bracket 20 to provide further adjustment of the dimensions of the belt 60 about the false tooth 14, as seen in FIG. 14. Similar to the previous embodiment, the false tooth 14 is preferably constructed with grooves and/or channels in the perimeter of the false tooth so as to incorporate the belt 60 seamlessly into the exterior of the false tooth 14. A dental putty or other suitable material may then be coated about the belt 60 to ensure that no rough edges remain from the belt 60 and to provide a seamless transition from the false tooth 14 to the belt 60.

It should be noted that those of ordinary skill in the art will appreciate from this disclosure that the present invention may further be used in accordance with a regular tooth, or any other dental device used within the field of orthodontics.

Referring to FIGS. 1-15, one preferred embodiment of the present invention operates as follows. A wearer 12 places the braces bracket 20 into position within a set of braces 10. The braces bracket 20 is preferably incorporated onto a false tooth 14. Once into position, a pin along the second opposing surface 28 of the braces bracket may be positioned into a cavity 16 within the false tooth 14. A coating 42 is then distributed into the cavity 16 and about the pin 40 and in between the second opposing surface 28 and the exterior of the false tooth 14 in order to secure the pin 40 and brace bracket 20 against the false tooth 14. In this way, a false tooth 14 may be efficiently and effectively incorporated into a set of braces 10 used by a wearer 12.

It is recognized by those skilled in the art that changes may be made to the above described methods without departing from the broad inventive concept thereof. It is understood, therefore, that this invention is not limited to the particular embodiments disclosed, but is intended to cover all modifications which are within the spirit and scope of the invention as defined by the above specification, the appended claims and/or shown in the attached drawings.

What is claimed is:

1. A system configured to secure a false tooth, comprising:
a main body of a braces bracket configured to contact the false tooth, the main body comprising first and second opposing surfaces,
an attachment mechanism disposed along the second opposing surface and configured to engage the false tooth, and
the main body being configured to engage a wire such that the main body can be integrated into a set of braces.

2. The system according to claim 1, wherein the attachment mechanism further comprises a pin configured for insertion into and/or through the false tooth.

3. The system according to claim 2, further comprising a cement coating disposed on the pin to facilitate securement of the pin into the false tooth.

4. The system according to claim 1, further comprising a plurality of supports configured to provide a catch, the plurality of supports configured to attach to the main body along the first opposing surface.

5. The system according to claim 4, wherein the plurality of supports are configured as a plurality of posts which project perpendicularly away from the first opposing surface of the main body and each further comprise a flange attached thereto.

6. The system according to claim 5, wherein the plurality of supports are configured to engage a band and position the band continuously adjacent to the first opposing surface.

7. The system according to claim 6, wherein the plurality of supports further comprises four posts, the four posts defining a channel to receive the band therein.

8. The system according to claim 1, wherein the second opposing surface is configured to directly abut the false tooth.

9. The system according to claim 7, wherein the second opposing surface is contoured to match a shape of the false tooth.

10. The system according to claim 1, wherein the attachment mechanism further comprises a cap configured to enclose the false tooth, the cap being attached to the second opposing surface of the main body.

11. The system according to claim 1, wherein the attachment mechanism further comprises a hook configured to engage the false tooth, the hook being attached to the second opposing surface of the main body.

12. A method of providing a system configured to secure a false tooth, the method further comprising:
providing a main body of a brace bracket configured to engage the false tooth,
positioning the main body on the false tooth, wherein the main body and the false tooth are configured to be integrated into a set of braces such that the set of braces can properly position the false tooth when the set of braces are installed.

13. The method according to claim 12, wherein the step of providing the main body further comprises providing a plurality of supports configured to provide a catch, the plurality of supports configured to attach to the main body along the first opposing surface.

14. The method according to claim 12, wherein the step of positioning the main body further comprises a step of providing an attachment mechanism disposed along the second opposing surface and configured to engage the false tooth.

15. The method according to claim 14, wherein the step of providing the attachment mechanism further comprises providing a pin configured for insertion into and/or through the false tooth.

16. A method of providing customization of a false tooth, comprising:
preparing a customized false tooth for a person, the customized false tooth being shaped according to the orthodontic shape of the person,
securing a braces bracket directly onto the false tooth,
providing a main body of a brace bracket configured to engage the false tooth,
positioning the main body on the false tooth, wherein the main body and the false tooth are configured to be integrated into a set of braces such that the set of braces can properly position the false tooth when the set of braces are installed.

17. The method according to claim 16, wherein the step of providing the main body further comprises providing a plurality of supports configured to provide a catch, the plurality of supports configured to attach to the main body along the first opposing surface.

18. The method according to claim 17, wherein the step of positioning the main body further comprises a step of providing an attachment mechanism disposed along the second opposing surface and configured to engage the false tooth.

19. The method according to claim 17, wherein the step of providing the plurality of supports further comprises the plurality of supports being configured as a plurality of posts which project perpendicularly away from the first opposing surface of the main body and each further comprise a flange attached thereto.

20. The method according to claim 18, wherein the step of providing the attachment mechanism further comprises providing a pin configured for insertion into and/or through the false tooth.
